(19) United States
(12) Patent Application Publication
(10) Pub. No.: US 2008/0319802 A1
(43) Pub. Date: Dec. 25, 2008

(54) LONG TERM CARE UNDERWRITING SYSTEM AND METHOD

(76) Inventors: Jonathan P. Abraham, Sudbury, MA (US); Mark Damian Newton, Auburndale, MA (US); Elizabeth A. Arsenault, Keene, NH (US); Wendy Chen, Fishkill, NY (US); Rachel A. Danson, Niwot, CO (US); Arthur C. Heinricher, Rutland, MA (US); Joanna B. Kluza, New Britain, CT (US); Mary A. Korch, Shillington, PA (US); Joseph F. Kraynak, State College, PA (US); Melissa A. Moon, Federal Way, WA (US); Nicholas E. Rackliff, Northborough, MA (US); William J. Treese, Rocky Hill, CT (US); Jaris B. Wicklund, Worcester, MA (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/766,895

(22) Filed: Jun. 22, 2007

(51) Int. Cl. G06Q 40/00

(52) U.S. Cl. 705/4

(57) ABSTRACT

A system and method for analyzing risk for underwriting insurance is provided. The method may comprise: inputting data regarding at least one applicant for insurance, wherein at least one item of data relates to a first category and at least one item of data relates to a second category; assigning a numerical risk factor to at least one item of data; generating a first numerical risk score for the first category; generating a second numerical risk score for the second category; generating a composite risk score based on at least the first numerical risk score and the second numerical risk score; assigning a composite risk score to at least one applicant for insurance; wherein the first category comprises medical conditions or severities of medical conditions and the second category comprises negative medical condition interactions.

### BACKGROUND

a. Technical Field

The invention relates generally to a system and method for assessing risk in an insurance underwriting context, and includes a system and method for assigning a composite risk score to an individual with respect to insurance analysis and decision making in connection with long-term care insurance.

b. Description of Related Art

Long term care is care provided to individuals who can no longer perform certain activities of daily living or who are cognitively impaired. Long term care insurance provides assistance in paying for future long term care services, such as nursing homes, in-home care, and other assistance programs. Long term care insurance may help cover expenses that health insurance may not cover. The demand for long term care insurance is increasing, in large part, due to societal changes. Among other things, people are generally living longer and are living on their own later in life. The elderly and disabled are now less likely to stay with family to receive care. Instead, it is more common that they live alone and require in-home care or that they live in an assisted living facility or nursing home. Such circumstances may also cause an increase in the demand for long term care services. Moreover, people with more economic means consider long term care insurance as a means to protect their assets.

However, unlike life insurance, where it is known that the purchased benefit amount will ultimately be paid so long as the insured keeps the policy in effect, with long term care insurance, the payment of benefits will depend on whether the insured becomes eligible for benefits due to a cognitive impairment or assistance needed with certain activities of daily living. This uncertainty as to whether insureds will ultimately require long term care services for which benefits will be payable can make the risks associated with long term care insurance more difficult to assess and premiums more difficult to determine.

Generally, underwriters review all of the application data for an insurance applicant to assess risk and decide if an applicant for long term care insurance should be accepted or declined. Underwriters use information available in proprietary underwriting guidelines that contain information regarding company policies, the application process, descriptions of the insuring process, definitions of terms, and methods for classifying applicants based on medical conditions and other characteristics of an applicant. Such underwriting guides may also indicate which conditions are co-morbid (i.e., negatively interact or have been determined to be adversely related). Underwriting guides may also include criteria for acceptable height and weight combinations, and specific medications that indicate an underwriting risk and, if applicable, how to assign a risk classification.

Underwriters generally assign accepted applicants into one of several risk classes (e.g., preferred, standard, or substandard classes) though it is also common for an underwriter to decline altogether to offer insurance coverage to applicants. Underwriters may also decline to accept an applicant. For example only, underwriters may use information available in underwriting guidelines with respect to assigning applicants into a risk class. A sample from an underwriting guideline is illustrated in FIG. 1. Underwriters generally determine the rate class into which applicants are placed, which in turn dictates the amount of the premium. Underwriters may also limit the coverage and/or modify the policy, for example, by setting various restrictions.

Underwriting for long term care insurance may be difficult and complex because long term care insurance is a newer insurance product with a smaller base of historical or empirical data. Further, there is a large amount of information to review when determining whether or not to issue a long term care insurance policy. In most cases, an underwriter will begin by reviewing an application that includes a detailed medical history report with information regarding prescription drugs and chronic diseases. The underwriter may also utilize a telephone interview to verify the application information and possibly administer a cognitive test to the applicant. Further, the underwriter will gather and review medical records and physician statements and records of prescription use. The underwriter may additionally conduct an in-person interview in order to obtain information about an applicant and the applicant's home environment. The underwriter will generally assess several different kinds of risk in his or her evaluation, including the risk associated with an applicant's likelihood of claiming benefits, the risk associated with the applicant's ability to make payment, and other risk associated with normal business operations.

It may be desirable to develop a model to compute a numerical risk score based on application information, including medical conditions, that can also be adaptive—for example, to underwriter behavior.

### SUMMARY

A system and method for analyzing risk for underwriting insurance is provided. The method may comprise: inputting data regarding at least one applicant for insurance, wherein at least one item of data relates to a first category and at least one item of data relates to a second category; assigning a numerical risk factor to at least one item of data; generating a first numerical risk score for the first category; generating a second numerical risk score for the second category; generating a composite risk score based on at least the first numerical risk score and the second numerical risk score; assigning a composite risk score to at least one applicant for insurance; wherein the first category comprises medical conditions or severities of medical conditions and the second category comprises negative medical condition interactions.

Various features of this invention will become apparent to those skilled in the art from the following detailed description, which illustrates embodiments and features of this invention by way of non-limiting examples.

### BRIEF DESCRIPTION OF THE DRAWINGS

Embodiments of the invention will now be described, by way of example, with reference to the accompanying drawings, wherein:

FIG. 1 is an entry of the type found in an underwriting guideline.

FIG. 2 is a general block diagram illustrating an aspect of an underwriting system in accordance with an embodiment of the invention.

FIG. 3 is an illustration of an interface for the inventive system in an embodiment.

FIG. 4 is a table illustrating a sample calculation of a Condition Risk Score.

FIG. 5 is a table illustrating sample risk factors assigned to various conditions.

FIG. 6 is a table illustrating a sample calculation of a Co-Morbidity Risk Score.

FIG. 7 is a sample of a co-morbidity table.

FIG. 8 is a table illustrating a sample calculation of a Functional Risk Score.

FIG. 9 is a table illustrating a sample calculation of a Lifestyle Risk Score.

FIG. 10 is a sample of a lifestyle table.

FIG. 11 is a flow chart illustrating an example of a pair-wise comparison test.

FIG. 12 is a block diagram generally illustrating a method in accordance with an embodiment of the invention.

FIG. 13 is a block diagram generally illustrating a method in accordance with an embodiment of the invention.

FIG. 14 is a general block diagram showing a method in accordance with an embodiment of the invention.

FIG. 15 is a table illustrating a sample distribution for generation of large numbers of sample applicants for system and method testing.

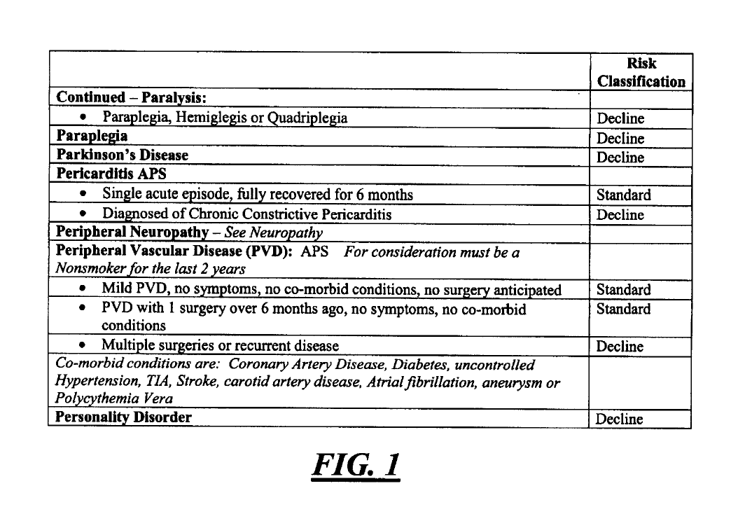

### DETAILED DESCRIPTION

Reference will now be made in detail to embodiments of the present invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as embodied in or defined by the appended claims.

The invention includes a system and method for assigning a composite risk score to an individual with respect to insurance analysis and decision-making, including with respect to long-term care insurance. Software may be used in the implementation of mathematical models in connection with various aspects of the system. The system may also be refined or “trained” using mathematical techniques. For example, without limitation, techniques such as numerical regression may be used to formulate model parameters and pair-wise comparisons between applicants and to verify the consistency of risk factors and model parameters, such as a discounting or compounding factors.

The composite risk score may be used by an insurance underwriter to assist in making coverage decisions or as an auditing tool to select underwriting decisions to review. The use of a composite risk score may provide an objective summary of large amounts of data or information relating to an applicant. The use of a composite risk score through the use of the inventive system and method may also, inter alia, enhance the consistency of decisions across various underwriters and venues, may expand the risk pool that may be considered “auto-approved,” may allow more underwriting classifications, and/or may provide flexibility over time to adjust risk assessment and classification.

The system and method may also be used as an information supplement to providers. The invention may convey the probability of approval via a web-access pre-screening tool, may provide information on historical dispersion of risk classification via web-access, may provide for higher issue/approval rates and/or lower underwriting costs by providing better screening and field underwriting at the time of sale, and/or may give non-expert sales people a simple risk screening process.

The system and method may also be used as a product differentiator to enable less-than-standard product development and risk classification and to provide research and experience analysis (e.g., actual experience used to fine-tune the scoring mechanism and data-mining by conditions, underwriting score, or specific risk factors).

In an embodiment, the invention may include an expert system that can assign a composite risk score to an applicant for long-term care insurance and may comprise an adaptive model. The expert system may be configured to mimic the decision-making process of an expert in a particular field. When multiple conditions or co-morbidities are present, an underwriter has to make a decision based on experience and intuition. The invention may be configured to take into account how underwriters view additional applicant characteristics as contributing to the total risk score. The expert system may also be based on information available in various underwriting guidelines used by underwriters.

The expert system may include a knowledge base, an inference engine, and/or a user-interface. The knowledge base may comprise a set of rules within a particular field. In a rule-based expert system, the knowledge base may contain a set of rules, which can be used to emulate the thought process of an expert. As data is provided by the user, the system may move through a set of possibilities, and may eliminate as many as possible, finally reaching a decision that is communicated to a user. The set of rules within the knowledge base may comprise the risks associated with each relevant application characteristic. The database of risk factors for applicant characteristics may be created by a user of the system or may be developed prior to use of the system and provided to the system user. In an embodiment, the database of risk factors may be created using a field guide and/or input from underwriters.

The inference engine may comprise a routine, a program, or an algorithm to reach a decision or hypothesis based on the data entered into the system. The inference engine of the inventive system may comprise a mathematical model that may calculate a composite risk score for an applicant for long term care insurance. The inference engine may take an applicant's information and characteristics as inputs and may generate as output a number (i.e. composite risk score) representing that applicant's risk. The composite risk score may be used to determine a rate class into which an applicant should be placed.

The user interface may comprise a program with which a user may interact with the expert system. The user interface may therefore make the system and method accessible to underwriters and/or others. In an embodiment, the user interface may comprise a spreadsheet that may perform calculations and provide the user with the results. In an embodiment, a program or routine (e.g., a macro) may be used to add a new applicant's information to a database and/or spreadsheet. For example, without limitation, when a program or routine, such as a macro, is run, it may bring up or interact with a user form, for example, in an object-oriented computer language that can be viewed (e.g., Visual Basic). The user may input an applicant's name, and information specific to various categories including, for example, those described below.

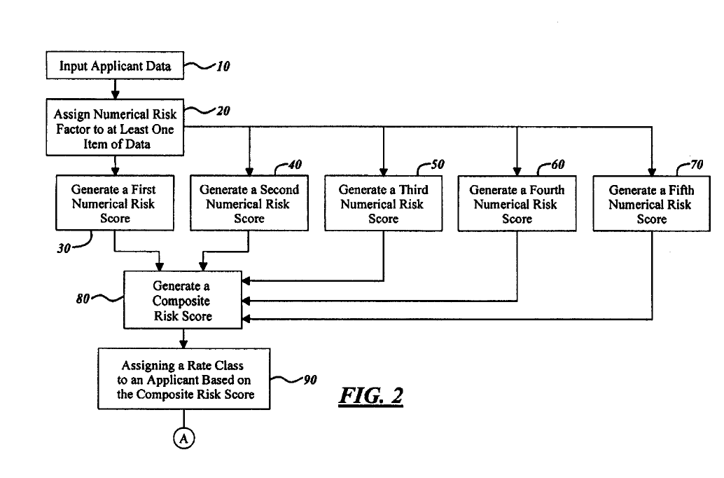

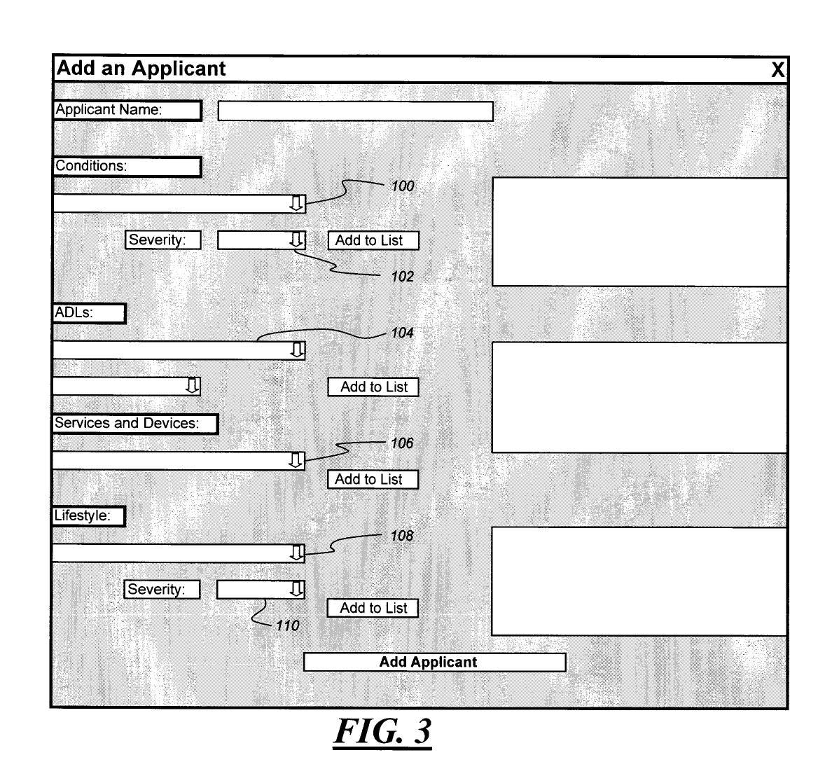

An embodiment of the invention is generally illustrated in FIG. 2. As illustrated, applicant data is inputted into the system (e.g., step 10). The input data may, for example, include medical conditions and severities, negative condition interactions (e.g., co-morbidities), functional information (i.e., information that may be associated with activities of daily living, including, for example, whether current assistance is needed in daily activities), lifestyle information (e.g., habits, hobbies, etc.), and medications or medical devices. In an embodiment, a user may specify or select condition(s) to add with respect to an applicant. For example, without limitation, a pop-up or drop-down list or checklist 100 may be provided that includes conditions present in a database or spreadsheet as illustrated in FIG. 3. If desired, such a listing may be loaded every time that a program or routine (such as a macro) is run. Moreover, the program or routine may be configured to handle updates, such as updates to the list of conditions.

Once a condition is selected, a user may specify or select a severity to associate with the condition. In an embodiment, a user may select an associated condition severity from severities that are presented as options to the user, such as, for instance, in a drop-down list or a checklist 102, for example, as generally illustrated in FIG. 3. The severity input may be designed and set up so as to only correspond to a condition that is currently selected, i.e., so only predetermined potential severities may be selected, which can help reduce user error and erroneous input. The input data and information may be visually displayed, e.g., on a screen, for review. A user may also input information relating to other categories or conditions in a similar manner. In an embodiment, a user may specify or select functional information, medications, medical services and devices, and lifestyle information to add with respect to an applicant. For example, without limitation, pop-up or drop-down lists or checklists 104, 106, 108 may be provided that include functional information, medications and medical services and devices, and lifestyle information, respectively, present in a database or spreadsheet, for example as generally illustrated in FIG. 3. In an embodiment, a user may select an associated lifestyle information severity from severities that are presented as options to the user, such as, for instance, in a drop-down list or a checklist 110 as generally illustrated in FIG. 3. In an embodiment, it is also possible that no severities may be chosen for one or more of the components of a category. In an embodiment, one or more categories of information may be combined and presented together, for example in a single drop-down list, checklist, and/or list box. At some point, whether before, during, or after the completion of data entry, the user may have the applicant's information added to the system. The inclusion in the system may involve the creation or inclusion of a formatted and/or stored entry for an applicant.

Referring again to FIG. 2, the inventive system and method may take as input up to all of the characteristics recorded in an applicant's file and may map select or characteristics identified as important to numerical risk factors (e.g., step 20). In an embodiment, the numerical risk factors may, for example, range from −100 to 1000. Although these numbers are mentioned in detail, it is understood by those of ordinary skill in the field that lower or higher risk factors may be used in connection with the invention system and method and remain within the spirit and scope of the invention.

Various categories of input data may be provided in connection with the system and method. In an embodiment of the system, there may be five categories of input data: (1) medical conditions—relating to Condition Risk Score (R_{C}), (2) negative condition interactions—relating to Co-morbidity Risk Score (R_{CM}), (3) medications used by applicant—relating to Medications Risk Score (R_{M}), (4) services, devices, activities of daily living, and instrumental activities of daily living information—relating to Functional Risk Score (R_{F}), and (5) habits of the applicant affecting long term care risk—relating to Lifestyle Risk Score (R_{LS}). Numerical risk factors may be assigned to items of input data in one or more categories (e.g., step 20).

These numerical risk factors may be used (e.g., combined) to arrive at (e.g., calculate) a numerical risk score in each category of input data (e.g., step 30). In an embodiment, numerical risk factors may be used to generate or otherwise arrive at a numerical risk score in five categories (e.g., steps 30-70). Although five categories are mentioned in detail, it is understood by those of ordinary skill in the art that fewer or more categories may be used and remain within the spirit and scope of the invention. The five categories of risk scores may comprise (1) a Condition Risk Score (R_{C}), (2) a Co-morbidity Risk Score (R_{CM}), (3) a Medications Risk Score (R_{M}), (4) a Functional Risk Score (R_{F}), and (5) a Lifestyle Risk Score (R_{LS}). Although these categories of risk scores are described in detail, it is understood by those of ordinary skill in the art that different categories of risk scores may be utilized and remain within the spirit and scope of the invention. Further, where several categories are involved, an associated item of data with respect to a given category may, if applicable, comprise a zero or an identification of the absence of an entry or score for such category. For example, without limitation, if a Lifestyle Risk Score (R_{LS}) is included in the assessment, and no items are implicated, the item of data associated with the category may be zero or some other identifier that permits the assessment to continue absent a score or other entry.

The calculation for each numerical risk score in each category may vary, as described in more detail below. The numerical risk scores in each category may then be used (e.g., combined) to produce (e.g., calculate or generate) a composite risk score (e.g., total risk score) (e.g., step 80).

The composite risk score may be based upon a combination of at least a Condition Risk Score (in which risk factors are assigned to various medical conditions to reach an overall numerical risk score for conditions) and a Co-morbidity Risk Score (which are negative, i.e., riskier, factors associated with condition interactions, such as co-morbid pairs, in order to reach an overall numerical risk score for co-morbidities).

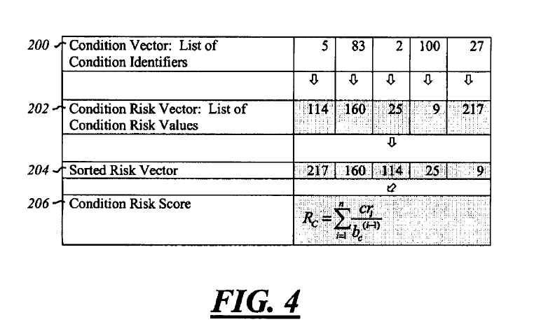

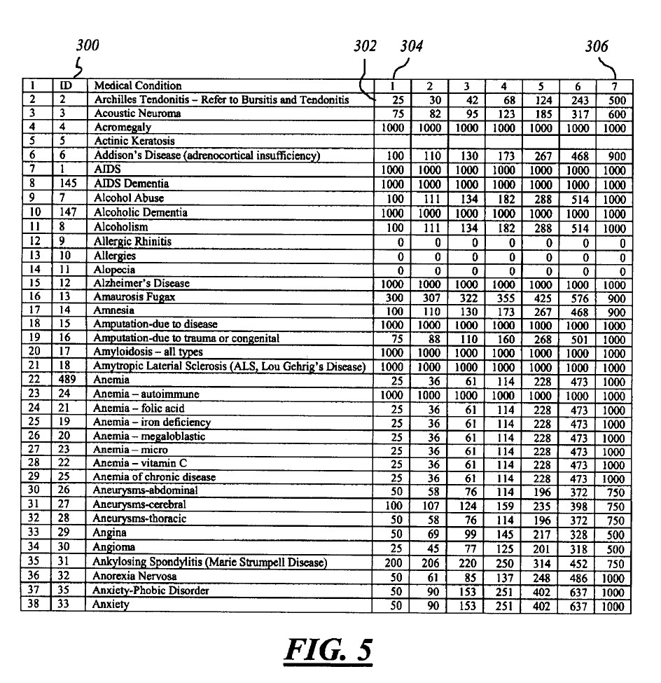

The Condition Risk Score (i.e., numerical risk score for medical conditions and severities) may be based upon underwriter-assigned risk factors (e.g., points) for individual conditions. The Condition Risk Score may be generated at step 30 in FIG. 2. Conditions refer generally to medical conditions that an applicant may have (e.g., diabetes or arthritis). Referring now to FIG. 4 which is a table illustrating a sample calculation of a Condition Risk Score, an identification number may identify one or more conditions in connection with step 200. A description or identification number of the condition may also be utilized that may designate the severity of a condition. Each condition and/or severity may be associated with condition risk factors at step 202. The risk factors may represent the individual numerical risk of each potential characteristic of an applicant. The risk factors may make up the knowledge base of the system. Referring now to FIG. 5, a table illustrating sample risk factors that may be assigned to various applicant conditions is provided. As generally shown in FIG. 5, each condition may have an identification number as provided in column 300. A numerical risk factor (e.g., 302) may be assigned to each condition depending upon the severity of each condition. As illustrated, the severity level assigned to each condition may, for example, range from a first level of severity (e.g., 304) to a seventh level of severity (e.g., 306). Although seven levels are described in detail, it is understood by those of ordinary skill in the art that fewer or more levels of severity may be used and remain within the spirit and scope of the invention.

In an embodiment, the system may provide for more than 480 different medical conditions, some of which may have as many as seven severities, or severity levels, associated with the condition. Although these numbers are mentioned in detail, it is understood by those of ordinary skill in the art that fewer or more medical conditions or severities may be used in connection with the invention system and method and remain within the spirit and scope of the invention.

Referring again to FIG. 4, a list of risk factors may be sorted in descending order (i.e., from greatest to least) at step 204. The list of risk factors may be discounted, and summed as shown in the calculation at step 206 in FIG. 4. As the number of medical conditions increases, the marginal impact of each new condition on the risk score may be lessened. Accordingly, each additional risk may be divided by a factor bₓ that is greater than 1, which may serve to diminish the effect of an applicant having a large number of minor conditions. Accordingly, the numerical risk score for the conditions category may show diminishing returns for each additional condition of an applicant.

The system may also provide information to help determine if the assigned risk factors for creating the numerical risk score are consistent. For example, if condition A is worse (i.e., riskier) than condition B, then score (A) could be greater than score (B). However, if condition A is equivalent to condition B, then score (A) could be approximately equal to score (B). A calculation for the medical conditions in order to determine a Condition Risk Score is provided below, where R_{C} is the Condition Risk Score, crᵢ is each individual condition's factor, and b_{c} is the factor by which the elements of the sum decrease (i.e., discounting factor):

$${R}_{C} = {\sum }_{i = 1}^{n} \frac{{cr}_{i}}{{b}_{c}^{( i - 1 )}}$$

In an embodiment, b_{c} may be approximately 1.23. Although this value is mentioned in detail, it is understood by those of ordinary skill in the art that various values, including those based upon experience, may be used for b_{c} and remain within the spirit and scope of the invention. When changing b_{c} and keeping the parameters in other risk score categories constant, there may be changes in the distribution of total risk scores. Applicants in the low (e.g., −100 to 100 points in an embodiment) range, who probably have none or only one medical condition, are not likely to be affected by changes in the value for b_{c}. However, with larger changes in b_{c}, there may be greater movement of applicants between risk classes to which applicants may be assigned based on their composite risk score, and a change in this parameter (e.g., b_{c}) may have the largest affect on applicants with high scores. An increase in the value of the parameter may decrease total risk scores. A decrease in the value of the parameter may increase total risk scores, and may generate a larger frequency of applicants moving into high-score risk classes. By way of example, without limitation, a 20% increase in the value for b_{c}, (e.g., from approximately 1.23 to approximately 1.54) may result in a majority (e.g., about 64%) of applicants having their total risk score decrease between about 0% and 1%, and a small minority (e.g., about 7%) of applicants having their total risk score decrease more than about 10%. A 20% decrease in the value for b_{c} (e.g., from approximately 1.23 to 1.03) may result in a majority (e.g., about 58%) of applicants having their total risk score decrease between about 0% and 1%, and a small minority (e.g., about 12%) of applicants having their total risk score decrease more than about 10%.

The system may employ a mathematical approach or model to determine how risk factors for several independent medical conditions may accumulate, and may use software to assist in implementation and testing of the system. Because the risk factors—and ultimately risk scores—represent risk, a higher score means an applicant is more likely to receive long term care in the future. Accordingly, risk factors may be positive numbers which affect the risk score negatively (i.e., the characteristics in each category may increase the risk score of an applicant). In one embodiment, however, the height and weight condition may have a negative risk factor, in the event that the applicant falls into a preferred range for height and weight that would be beneficial to an applicant's score. In another embodiment, lifestyle characteristics may also be beneficial and have a negative value, which may affect the risk score positively (i.e., the lifestyle characteristics may decrease the risk score of an applicant).

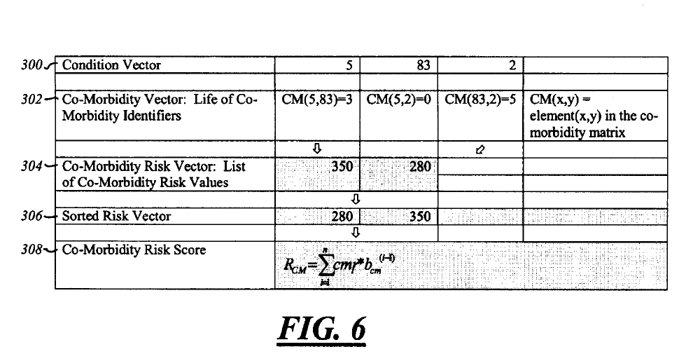

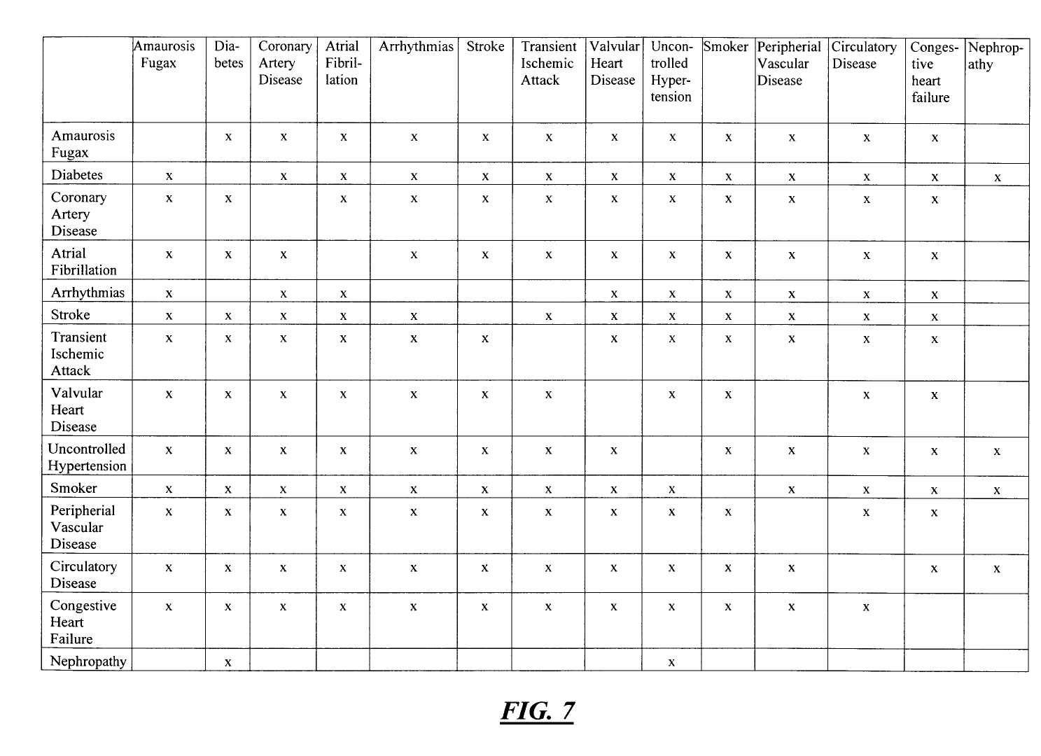

Co-morbid pairs are generally defined as pairs of specific conditions that interact negatively. Such pairs of conditions are typically identified by underwriters. For example, a co-morbid pair may include coronary artery disease and arrhythmias, which generally interact negatively. Further, each co-morbid pair may have a risk factor (e.g., numerical points) assigned to it. The Co-morbidity Risk Score may be considered an additional risk score that results from the concept that the sum may be greater than the parts. The Co-Morbidity Risk Score may be generated at step 40 in FIG. 2. By way of example, without limitation, condition A may be worth 100 points and condition B may be worth 200 points. However, if an applicant has both conditions A and B, and if conditions A and B are identified as a co-morbid pair, the associated or assigned point may exceed 300. Referring now to FIG. 6 which includes a table illustrating the calculation for the Co-Morbidity Risk Score, an identification number may identify the conditions that an applicant may have at step 300. A matrix may be used to correlate at least one item of data (e.g., an identification number for a condition) with another item of data (e.g., another identification number for another condition) in order to determine whether a negative interaction and/or co-morbidity exists at step 302. By way of example, without limitation, a matrix, such as that generally illustrated in FIG. 7, may be used to make a correlation. In another embodiment, a square matrix may be used that comprises a list of conditions along both the x and y axes. If a co-morbidity exists between the two conditions for each cell, the risk associated with that co-morbidity is the value (e.g., numerical risk points) of the cell. If no co-morbidity exists, the value of the cell may be zero. Each negative interaction and/or co-morbidity may be associated with condition risk factors. Referring again to FIG. 6, risk factors (e.g., numerical points) may be assigned to each negative interaction and/or co-morbidity as illustrated at step 304. A list of risk factors may be sorted in ascending order (i.e., from least to greatest) at step 306. The list of risk factors may be compounded, and summed, for example, as generally illustrated in the calculation at step 308 in FIG. 6.

Each co-morbid pair may be multiplied by a factor b_{cm} that is greater than 1, which may grow exponentially as the number of co-morbidities increases (e.g., a compounding factor). This may be in keeping with the principle that the risk for having multiple co-morbidities is greater than merely the sum of those individual risks. The sum for co-morbidities may therefore have a compounding effect, and each co-morbid pair may have increased marginal effect on the risk score.

A calculation for determining a Co-morbidity Risk Score is provided below, where R_{CM} is the Co-morbidity Risk Score, cmrᵢ is the factor associated with each co-morbidity, and b_{cm} is the factor by which the elements of the sum increase.

$${R}_{CM} = {\sum }_{i = 1}^{n} {cmr}_{i} * {b}_{cm}^{( i - 1 )}$$

In an embodiment, b_{cm} may, for example, be approximately 1.70. Although this value is mentioned in detail, it is understood by those of ordinary skill in the art that various values may be used for b_{cm} and remain within the spirit and scope of the invention. In an embodiment, the system includes a formula for the co-morbidity risk factors, such as the foregoing. Because each co-morbidity may be affected by the severity of the conditions, the risk factor for the co-morbidity may take this into account. Accordingly, the formula for the co-morbidity risk factors may recognize the severity of the individual conditions, as well as the inherent severity of the co-morbidity

Information relating to medications and/or medical devices used by the applicant may be assigned a numerical risk score of R_{M}. The Medications Risk Score R_{M} may be generated at step 50 in FIG. 2. In an embodiment, the numerical risk score for medications may be determined by assigning risk points to each individual medication and/or medical device used by the applicant. In an embodiment, each additional risk for medication and/or medical devices may be discounted, i.e., divided by a factor bₘ that is greater than 1, which may serve as a discounting factor to diminish the affect of an applicant having a large number of minor medications and/or medical devices. In another embodiment, each additional risk for medication and/or medical devices may be compounded, i.e., multiplied by a factor bₘ that is greater than 1, which may serve as a compounding factor to increase as the number of medications increases, for example, in situations where there may be medication interactions.

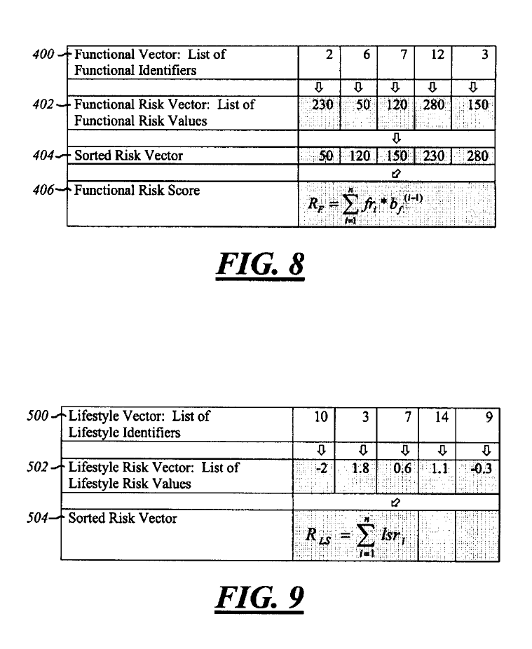

Functional information (e.g., activities of daily living, instrumental activities of daily living, services, devices) may be assigned a numerical risk score of R_{F}. The Functional Risk Score R_{F} may be generated at step 60 in FIG. 2. Activities of daily living may include, without limitation, bathing, toileting, dressing, continence, transferring, eating, ambulating, and mobility. Instrumental activities of daily living may include, without limitation, laundry, ability to arrange for transportation, taking medication, cooking/meal preparation, shopping, the ability to use the telephone, housekeeping, and the ability to handle personal finances. Referring now to FIG. 8 which is a table illustrating a sample calculation for a Functional Risk Score, an identification number may identify the functional information that may apply to an applicant at step 400. Each element in the functional information category may have a factor (i.e., risk points). Risk factors may be assigned to each element of functional information as illustrated at step 402. These risk factors may be may be sorted in ascending order (i.e., from least to greatest) at step 404. The list of risk factors may be compounded, and summed, for example, as generally illustrated in the calculation at step 406 in FIG. 8.

By way of example, a calculation for determining a Functional Risk Score is provided below, where R_{F} is the Functional Risk Score (i.e., the total risk of the functional category), frᵢ is the factor associated with each functional element, and b_{f} is the factor by which the elements of the sum increase (i.e., a compounding factor):

$${R}_{F} = {\sum }_{i = 1}^{n} {fr}_{i} * {b}_{f}^{( i - 1 )}$$

In an embodiment, b_{f} may be approximately 2.30. Although this value is mentioned in detail, it is understood by those of ordinary skill in the art that various values may be used for b_{f} and remain within the spirit and scope of the invention.

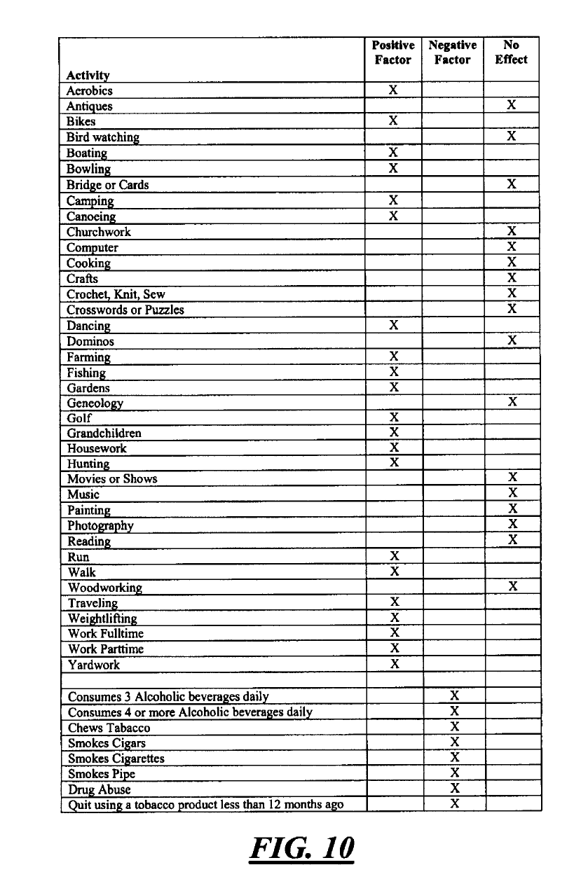

The system may also provide for lifestyle calculations that may add bonuses or penalties to the total risk score based on lifestyle information. These bonuses or penalties may be relatively small in comparison to the other components of the composite risk score. A Lifestyle Risk Score R_{LS} may be generated at step 70 in FIG. 2. Referring now to FIG. 9 which is a table illustrating a sample calculation of a Lifestyle Risk Score, an identification number may identify the lifestyle information that may apply to an applicant at step 500. Each element in the lifestyle information category may have a factor (i.e., risk points). Risk factors may be assigned to each element of lifestyle information as illustrated at step 502. The lifestyle risk factors may be positive or negative numbers, such that they may either increase or decrease the category risk score, respectively. A negative number may mean that the habit is healthy (i.e., negative risk). A positive number may mean that the habit is unhealthy (i.e, positive risk). For example only, if an individual has healthy eating habits, the corresponding risk factor may decrease their score and possibly move them into a better rate class. However, for example only, if the applicant has a lifestyle characteristic which is detrimental to his or her health, such as smoking or excessive drinking, this may increase his or her risk score, and therefore, would have a positive risk factor. Referring now to FIG. 10, a table illustrating sample lifestyle information that may be used in the inventive system and method is provided. The lifestyle factors may be independent of each other and may be summed so that there is no interaction between risks in this category. The list of risk factors in the lifestyle category may be summed, for example, as shown in the calculation at step 504 in FIG. 9. An example of a calculation for the addition of lifestyle bonuses or penalties is provided below, where R_{LS} is the lifestyle risk score and lsrᵢ is the risk factor associated with each element:

$${R}_{LS} = {\sum }_{i = 1}^{n} {lsr}_{i}$$

A math model may be used to assign a composite (i.e., total) risk score. All of the individual risk scores for the various categories may then be used to determine a composite risk score (i.e., Total Risk Score). A calculation for the composite risk score may be generated at step 80 of FIG. 2. The components of the Condition Risk Score and the Co-morbidity Risk Score may be weighted by assigned coefficients. The components of the medication data (i.e., Medications Risk Score), functional data (i.e., Functional Risk Score), and lifestyle data (i.e., Lifestyle Risk Score) may also be weighted by assigned coefficients. For example, a calculation for the composite risk score is provided below.

R_{T}=w_{c}R_{C}+w_{cm}R_{CM}+wₘR_{M}+w_{f}R_{F}+wₗₛR_{LS}

The model parameters, including the discounting and compounding factors in the various calculations, may be tested and refined. In an embodiment, two applicants deemed approximately equivalent risk-wise by an underwriter may be used in an iterative process to set up an equation to solve for one or more discounting factor or compounding factors. Accordingly, the system and method may provide for a refining or “training” of the model. For example, without limitation, mathematical principles, such as numerical regression and least squares approaches may be used to solve for model parameters and pair-wise comparisons between applicants and to better verify the consistency of the parameters and risk factors. The total risk score, R_{T}, may be relatively insensitive to small changes in the parameters. For example, a significant percentage (e.g., 93%) of total risk scores for the population may change by less than 10%, with a 20% increase in the conditions discounting factor, b_{c}.

The assigned coefficients (e.g., w_{c}, w_{cm}, wₘ, w_{f}, and/or wₗₛ) may depend on the number and magnitude of risk factors in an embodiment or may be independent of the magnitude of the risk factors in another embodiment. Such assigned coefficients may be tested and refined. Data from the generated applicants may be used in determining the assigned coefficients.

Numerical regression may be employed to solve for model parameters and may, for example, employ a form of linear regression known as least squares or other mathematical methods for finding the best-fitting curve for a given set of data points. The method may, for instance, involve attempting to minimize the sum of the squared residuals between the curve and the data points. These residuals, or offsets, are the distance between the curve of best fit and the observed data values and are measured vertically. The result of the method, in the case of linear least squares, may be a straight line that serves as the best fit for the given data. Such a method may also be generalized in order to incorporate nonlinear models. In a linear least squares approach, the sum of the squared residuals is used, instead of the absolute values of the residuals, because it allows them to be treated as a continuous and differentiable quantity, which may be necessary for minimization. In another approach, a data manipulating program, such as MATLAB, may be used to determine system and method parameters using a method based on least absolute deviations to solve for the compounding and discounting factors in the model.

A pair-wise comparison between applicants may be used to verify the consistency of the parameters and risk factors. A pair-wise comparison may use applicants evaluated as equivalents by underwriters to check the model parameters. The goal or objective of a pair-wise comparison test is to find two applicants, with characteristics in only a single category, who would commonly be deemed equivalent (i.e., risk-wise) by an underwriter. Accordingly, the two applicants' risk score calculations may be set equal to each other to solve for the discounting/compounding factor in the corresponding category. This value may then be compared to the parameter value to check for consistency. If a difference is uncovered, the parameter may need to be changed slightly to better fit the model. A difference may also mean that the risk factors relating to any or all of the characteristics present for both applicants are not really indicative of the inherent risk of those characteristics and may need to be changed as well.

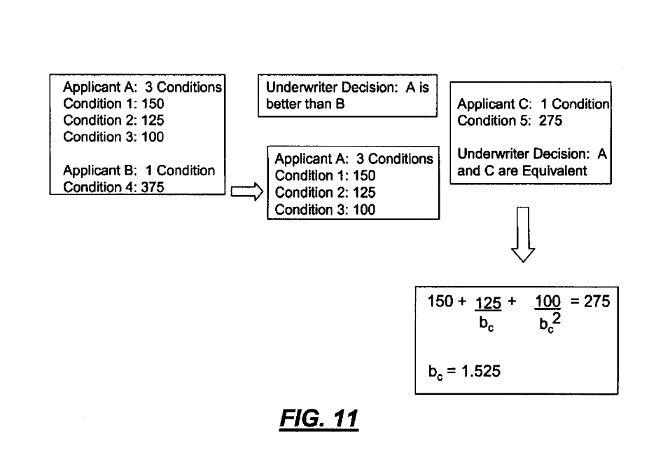

For example only, a pair-wise comparison may assist an underwriter in finding equivalent applicants. For example, if an Applicant A has three conditions with corresponding risk factors of 150, 125, and 100 and an Applicant B has a single condition with a corresponding risk factor of 375, Applicant A would be expected to have a lower risk score based on discounting that may be present in the conditions category score, such that Applicant A may be considered less of a risk. Instead, an Applicant C may replace Applicant B with a single condition with a lower risk score, such that Applicants A and C may be compared to check for equivalence. Upon deciding that a pair of applicants are approximately equivalent, the discounting factor may now be determined based on the calculation for R_{C}. An example of a pair-wise comparison test is generally illustrated in FIG. 11. In addition, a pair-wise comparison may be used to identify inappropriate risk factors for characteristics. For example only, if Applicant A had three conditions with corresponding risk factors of 150, 125, and 100, as set forth above, and applicant B has a single condition with a corresponding risk factor of 375, but an underwriter would determine that Applicant A has a higher risk than Applicant B, it would suggest that the conditions of Applicant A actually have a compounded effect on the score, which is contrary to underwriter intuition and would not comport with the system. Accordingly, either Applicant B's condition has too high a risk factor or Applicant A's conditions have risk factors that may be too low. Such pair-wise comparisons may assist underwriters in refining risk factors over time with additional data to improve performance of the system.

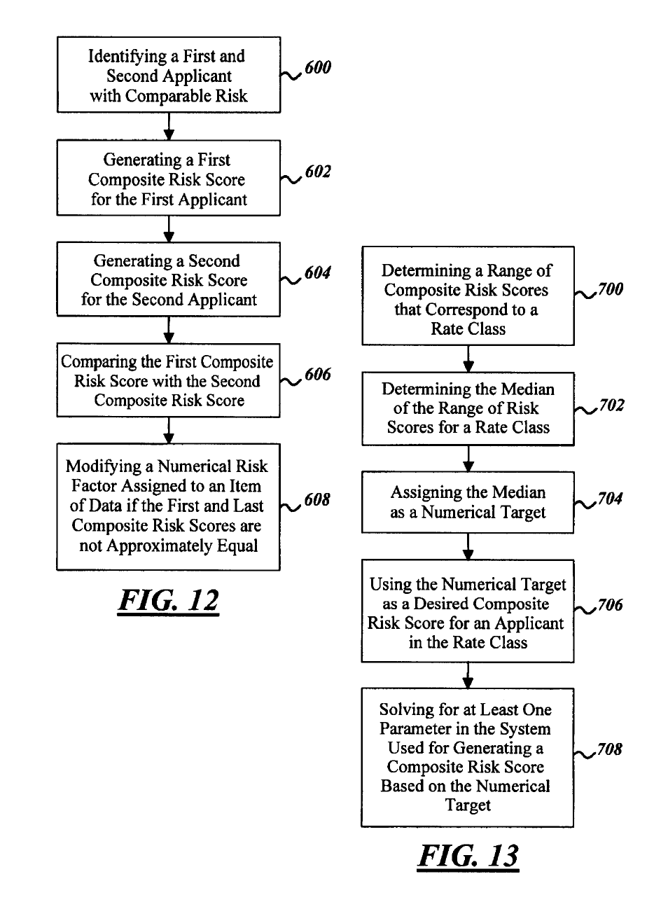

Referring now to FIG. 12, a block diagram showing a pair-wise comparison is generally provided. Step 600 may comprise identifying a first and second applicant with comparable risk (i.e., comparable risk based on experience of underwriters and/or based upon an underwriter's field guide). Step 602 may comprise generating a first composite risk score for the first applicant (i.e., in accordance with the inventive system). Step 604 may comprise generating a second composite risk score for the second applicant (i.e., in accordance with the inventive system). Step 606 may comprise comparing the first composite risk score with the second composite risk score in order to determine if the composite risk scores are approximately equal or equivalent within a specified range. Step 608 may comprise modifying a numerical risk factor assigned to an item of data (i.e., used to generate a composite risk score in accordance with the inventive system) if the first and second composite risk scores of comparable applicants are not approximately equal.

An underwriter may assign an applicant to one of several risk classes that correspond to the general risk of the applicant. In an embodiment of the inventive system, a rate (i.e., risk) class may be assigned to an applicant based on the applicant's composite risk score generated by the system (e.g., step 90 of FIG. 2). These risk classes may be divided into “bins.” These “bins” may include low, medium, and high risk bins. Because the risk points range from scores of −100 to 1000, the ranges that may identify the risk class that an applicant may be assigned to may fall within this range as well. For example, if an applicant had a single condition that, based on an Underwriter's Field Guide may put them into Class 2 (i.e., medium risk), then the risk score for that condition must correspond to the range of scores for Class 2. A target risk class may be introduced and may be converted into a target risk score. A median score in each risk bin may be the target risk score. This target risk score may be important for the calibration of the system model. By determining model parameters with use of actual underwriter decisions, appropriate target scores may be indicated that will provide calibration of the model parameters that would make the model consistent with underwriter evaluations. The system model may take rules specified by an underwriter and apply them. The output of the inventive system and model may generally follow the following criteria: (1) if applicant A is a higher risk than applicant B, then score (A) should be greater than score (B); (2) if applicant A is approximately equivalent to applicant B, then score (A) should be approximately equal to score (B); and (3) an applicant should be assigned to its correct risk class based on the Underwriter's Field Guide. The user interface for the inventive system may allow underwriters to enter their own evaluations or target scores, for each of the applicants listed in connection with the inventive system and method. In an embodiment, a spreadsheet may allow the underwriter targets to be imported into a data manipulation program, such as MATLAB, to be used in parameter determination. The underwriter targets may assist in calibration of the model parameters.

The system and method may be configured to include a vector of target scores, which may represent the actual numerical value to which the model of the system and method should map each applicant. One method for determining target scores may be based on the actual risk factors. For each category, since each additional condition may be discounted, and there is a maximum number of five conditions for any given applicant, the target for that category may be the sum of the first two, or two largest, condition risk factors. For co-morbidities, which are compounded, all of the co-morbidities present may be summed and then multiplied by a constant (e.g., 2). The functional target may be determined in the same way as the co-morbidities target. Targets may be determined for additional categories of input data. After finding individual targets for each category (e.g., conditions, co-morbidities, and functional information), they may be summed to determine the target score for the applicant.

Referring now to FIG. 13, a method for calibrating the system in order to attempt to ensure that the system is configured to generate composite risk scores that will place applicants in the appropriate rate class is illustrated. Step 700 may comprise determining a range of composite risk scores that correspond to a rate class (e.g., low risk, medium risk, high risk, etc.). Step 702 may comprise determining the median of the range of risk scores for a rate class. Step 704 may comprise assigning the median as a numerical target. Step 706 may comprise using the numerical target as a desired composite risk score for an applicant in the rate class. Step 708 may comprise solving for at least one parameter (e.g., discounting factor or compounding factor) in the system by using the numerical target.

By using a matrix with sample applicant data and a vector of hypothetical target scores, a vector of discounting and compounding factors may be determined. The approach may use the following calculation, where R is the vector of residuals, b is the vector of target scores, A is the matrix containing the applicant information, and x is the vector of discounting and compounding factors.

R=|b−Ax|

The algorithm may check 100, for example, possible values for each of the three types of risk factors. For the conditions factors, it may look at all values from 0 to 1, in increments of 0.01. For both the functional and co-morbidities factors, the program may look at values from 1.1 to 11, in increments of 0.1. For every combination of possible factors, the system may calculate the scores for each applicant. The system may then look at the absolute value of the difference between the scores and the targets. The sum of all the residuals may be calculated, and the system may attempt to find the combination where this value may be minimized. The system may then return the set of parameters (e.g., factors) that will minimize the absolute residual for the given set of data, and determine the associated residual.

The system may be configured to be adaptive (i.e., the system can track errors and error frequency that a condition is involved in error and distinguish slow trends from sharp changes in risk assignment) and can analyze an applicant pool for risk distribution (i.e., the model may be queried to discover if there are risk conditions that appear to be under-scored or over-scored by the risk points assigned to them). The system may be configured to remove most random error.

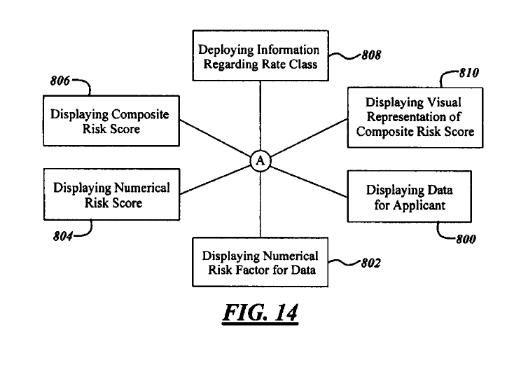

The system may be configured for use with a spreadsheet in order to calculate composite risk scores for a large number of applicants. The inventive functions and calculations may be performed by a set of macros within a spreadsheet (e.g., Excel spreadsheet), and the information required by the macros may be contained within worksheets of the spreadsheet. Referring now to FIG. 14, various types of information may be displayed for review by a user of the inventive system and method. For example, in an embodiment, a first worksheet may include and/or display all of the applicants' characteristics (e.g., information about an applicant's conditions, functional limitations, activities of daily living, instrumental activities of daily living, and lifestyle habits) (e.g., 800 in FIG. 14). For conditions, activities of daily living, instrumental activities of daily living, and lifestyle characteristics, severities may also be contained for each entry. Subsequent worksheets may include information about the individual risk factors associated with each category (e.g., worksheets entitled, for example, “Conditions,” “Co-morbidities,” “Functional,” and “Lifestyle”) (e.g., 802 in FIG. 14). These worksheets may include information regarding the name and/or severity of each condition, activity of daily living, service, device, lifestyle habit, etc. These worksheets may also include negative risk factors, which may represent a beneficial habit for an applicant. These worksheets may also include additional risk factors that may be associated with co-morbidities (e.g., a square matrix containing a list of conditions along both x and y axes, with a risk value for each potential co-morbidity, that may be zero). The names of medical conditions may be identical in both the conditions worksheet and the co-morbidities worksheet for searching purposes in order to ensure that the spreadsheet may correctly determine co-morbidities based on the applicant's inputs and perform the risk calculations correctly. In addition, all different versions of the each condition (e.g., cerebral anemia and thoracic anemia) may be included in the co-morbidities table in order to ensure that the spreadsheet may correctly determine co-morbidities based on the applicant's inputs and perform the risk calculations correctly. In other embodiments, pattern-matching may be used in the search process for the spreadsheet (i.e., if an applicant had any type of anemia, the spreadsheet may automatically reference the entry in the co-morbidity matrix for general anemia).

Subsequent worksheets may contain information regarding the applicable discounting or compounding factor for each category of risk that may be calculated in the model. Subsequent worksheets may include numerical risk scores for at least one category of data (e.g., 804 in FIG. 14) and an applicant's composite (i.e., total) risk score (e.g., 806 in FIG. 14). Below these factors may be numbers representing the ranges used for a histogram that may be created by the macro (e.g., ranges for various rate classes such as 808 in FIG. 14). These ranges may be altered in order to see a different range of classes in the histogram. Subsequent worksheets may also include a visual representation, such as a chart, graph, or histogram of the composite risk score (e.g., 810 in FIG. 14).

Finally, the spreadsheet may contain a series of worksheets that are used to display the results of the risk calculations (i.e. worksheets entitled “Calculations”). In an embodiment, the results may comprise four worksheets, although it is understood by those of ordinary skill in the art that fewer or more worksheets may be used and remain within the spirit and scope of the invention. In an embodiment, the first worksheet may list details regarding the calculations for the most recent application. It may include the risk factors for each individual element, a sorted vector of risk factors (if applicable) (i.e., how the risk factors were sorted), a vector with a discounting or compounding factor applied (if applicable) (i.e., how the risk factors were discounted and/or compounded), and a total risk for each category. It may also include the applicant's composite (i.e., total) risk. In an embodiment, the second worksheet may contain the total risk for each of the applicants contained in the spreadsheet. In an embodiment, the third and fourth worksheets may display graphs pertaining to the applicant calculations, including, for example, a “Distribution” worksheet which may contain a histogram displaying the distribution of the total risk scores and a “Total Risks” worksheet which may contain a bar graph displaying the respective total risk of each applicant that has been calculated.

The system may further be configured to include a detailed review for each individual applicant, including for example, a histogram showing score distribution. In an embodiment, the inventive system may be configured to allow a user to see details about an individual applicant's calculations by providing a userform that allows the user to select an applicant for whom he or she would like to see detailed calculations.

The system may further be configured to include a program or macro that automatically performs the risk calculations for all of the applicants currently in the system, and after each calculation may add the applicant's total risk to the results.

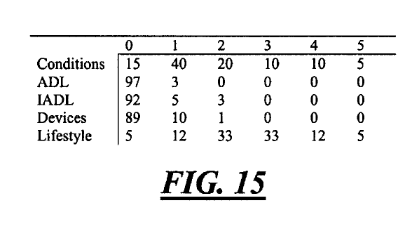

The system may further be configured to automatically generate large numbers of sample applicants for model testing. For example, FIG. 15 is a table illustrating a sample distribution for generation of large numbers of sample applicants to be used for system and method testing. The number of sample applicants may vary and may be determined by the user. The applicants may be generated based on a distribution defined by the user in a worksheet (e.g., a probabilistic distribution). The distribution may determine the percentages of the population who have a certain number of characteristics in each category. For each category, a random number may be generated that determines the number of characteristics. Random number generation may also be used to determine the specific characteristics for an applicant. For example, a random number generator may randomly pick a number between 0 and 1 and use this number to determine a random number of characteristics within each category that are to be given to the applicant. For each of these characteristics, there is a randomly generated number that may determine the specific characteristics to be chosen.

The system may further be configured to include a macro to transform all relevant data about applicants in a spreadsheet into a matrix form. The matrix may contain all of the sorted risk factors for the characteristics that applicants have. Each applicant may be represented as a row in the matrix, and the number of columns may be the number of sample applicants that are being used. A matrix may be imported into a data manipulation program (e.g., MATLAB) to allow the sample applicant data to be used in determining the optimal model parameters. The data generated by the macro may be stored in the data worksheet, such as a MATLAB worksheet.

The system and method may seek to minimize the sources of error, including without limitation the variations in the underwriter assessment, placing applicants in risk “bins,” the assigned condition risk points, and the risk score coefficients in each category. The system may be configured to eliminate error when the sources of error may be isolated.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. A method for analyzing risk for underwriting insurance, comprising:
inputting data regarding at least one applicant for insurance, wherein at least one item of data relates to a first category and at least one item of data relates to a second category;
assigning a numerical risk factor to at least one item of data;
generating a first numerical risk score for the first category;
generating a second numerical risk score for the second category;
generating a composite risk score based on at least the first numerical risk score and the second numerical risk score; and
assigning a composite risk score to at least one applicant for insurance;
wherein the first category comprises medical conditions or severities of medical conditions and the second category comprises negative medical condition interactions.

2. A method in accordance with claim 1, wherein at least one item of data relates to a third category.

3. A method in accordance with claim 2, wherein the third category comprises one of functional information, lifestyle information, medications, and medical devices.

4. A method in accordance with claim 3, further comprising generating a third numerical risk score for the third category;
generating a composite risk score based on at least the first numerical risk score, the second numerical risk score, and the third numerical risk score.

5. A method in accordance with claim 1, wherein at least one item of data relates to a third category, at least one item of data relates to a fourth category, and at least one item of data relates to a fifth category.

6. A method in accordance with claim 5, wherein the third category comprises functional information, the fourth category comprises lifestyle information, and the fifth category comprises medications and medical devices.

7. A method in accordance with claim 6, further comprising:
generating a third numerical risk score for the third category;
generating a fourth numerical risk score for the fourth category;
generating a fifth numerical risk score for the fifth category;
generating a composite risk score based on at least the first numerical risk score, the second numerical risk score, the third numerical risk score, the fourth numerical risk score, and the fifth numerical risk score.

8. A method in accordance with claim 1, wherein a numerical risk factor may be divided by a discounting factor or multiplied by a compounding factor.

9. A method in accordance with claim 8, wherein the first numerical risk score is equal to the sum of each risk factor assigned to the data in the first category divided by a discounting factor with an exponent based on the number of risk factors in the first category.

10. A method in accordance with claim 9, wherein the discounting factor is equal to about 1.23.

11. A method in accordance with claim 8, wherein the second numerical risk score is equal to the sum of each risk factor assigned to the data in the second category multiplied by a compounding factor with an exponent based on the number of risk factors in the second category.

12. A method in accordance with claim 11, wherein the compounding factor is equal to about 1.70.

13. A method in accordance with claim 4, wherein the third numerical risk score is equal to the sum of each risk factor assigned to the data in the third category multiplied by a compounding factor with an exponent based on the number of risk factors in the third category.

14. A method in accordance with claim 13, wherein the compounding factor is equal to about 2.30.

15. A method in accordance with claim 4, wherein the third numerical risk score is equal to the sum of each risk factor assigned to the data in the third category.

16. A method in accordance with claim 15, wherein each risk factor assigned to data in the third category may be positive or negative.

17. A method in accordance with claim 1, wherein the composite risk score is equal to the sum of the first numerical risk score multiplied by a first coefficient and the second numerical risk score multiplied by a second coefficient.

18. A method in accordance with claim 1, further comprising assigning a rate class to at least one applicant for insurance based on the composite risk score.

19. A method in accordance with claim 8, wherein the discounting factor or compounding factor is calculated by at least one of numerical regression, a comparison of two applicants for insurance, or least absolute deviations.

20. A method in accordance with claim 1, further comprising:
identifying a first and second applicant for insurance with comparable risk;
comparing a composite risk score generated for the first applicant with a composite risk score generated for the second applicant; and
modifying the numerical risk factor assigned to at least one item of data if the composite risk score generated for the first applicant is not approximately equal to a composite risk score generated for the second applicant.

21. A method in accordance with claim 1, further comprising:
displaying data regarding at least one applicant for insurance;
displaying at least one numerical risk factor assigned to at least one item of data;
correlating at least one item of data in the first category to at least one other item of data in the first category;
displaying a first numerical risk score;
displaying a second numerical risk score; and
displaying at least one composite risk score.

22. A method in accordance with claim 1, further comprising:
displaying information regarding at least one rate class to which an applicant may be assigned, said rate class corresponding to the composite risk score.

23. A method in accordance with claim 1, further comprising:
displaying a visual representation of the composite risk score for a plurality of applicants for insurance.

24. A method for calibrating a model for analyzing risk for underwriting insurance, comprising:
assigning a rate class to an applicant for insurance, the rate class corresponding to classifications assigned to applicants;
determining a numerical target that corresponds to a median of the rate class;
assigning the numerical target as a composite risk score for the applicant; and
solving for at least one parameter used in generating the composite risk score.

25. A method in accordance with claim 24, wherein the rate class is designated or assigned by an underwriter.

26. A method in accordance with claim 24, wherein the composite risk score comprises a score based upon at least a first category and a second category, the first category comprising medical conditions or severities of medical conditions, and the second category comprising negative medical condition interactions.

27. A method in accordance with claim 24, wherein the model is revised to take into account the at least one parameter that is solved for and used to generate the composite risk score.

28. A method for analyzing risk for underwriting insurance comprising:
inputting data regarding at least one applicant for insurance;
assigning numerical risk factors to at least one item of the data;
generating a condition risk score based on the numerical risk factors assigned to input relating to medical conditions of the applicant;
generating a co-morbidity risk score based on the numerical risk factors assigned to input related to negative medical conditions interactions; and
generating a composite risk score based on at least the condition risk score and the co-morbidity risk score.

29. A system for analyzing risk for underwriting insurance, comprising:
an interface for inputting information regarding at least one characteristic of at least one applicant for insurance, wherein at least one characteristic relates to a first category and at least one characteristic relates to a second category;
a database comprising values for association with or assignment to at least one characteristic of at least one applicant for insurance; and
an inference engine, wherein the inference engine is configured to take the information regarding at least one characteristic of at least one applicant for insurance as input and generate an output, the output comprising a numerical composite risk score representing the risk of at least one applicant for insurance,
wherein the first category comprises medical conditions or severities of medical conditions and the second category comprises negative medical condition interactions.

30. A system in accordance with claim 29, wherein the interface is a user interface.

31. A system in accordance with claim 30, wherein the user interface comprises a graphical user interface.

32. A system in accordance with claim 29, wherein the inference engine comprises a processor.

33. A system in accordance with claim 29, including a means for displaying the output.

34. A system in accordance with claim 29, wherein the inference engine comprises a routine, program, or algorithm.

35. A system in accordance with claim 29, wherein the database comprises a knowledge database including a set of rules.

36. A system in accordance with claim 29, wherein the database proceeds through a set of possibilities and eliminates those that are not deemed to apply from consideration.

37. A system in accordance with claim 29, wherein the database includes risk factors associated with at least one characteristic.

38. A system in accordance with claim 37, wherein at least one risk factor is provided by a system user.

39. A system in accordance with claim 37, wherein at least one risk factor is based on information provided by an underwriter.

40. A system in accordance with claim 29, wherein the inference engine applies a discounting factor or compounding factor to a component of the composite risk score.

41. A system in accordance with claim 29, further comprising a means for assigning a rate class to at least one applicant for insurance based on the composite risk score.

42. A system in accordance with claim 29, further comprising a means for: identifying a first and second applicant for insurance with comparable risk, comparing a composite risk score generated for the first applicant with a composite risk score generated for the second applicant, and modifying the numerical risk factor assigned to at least one item of data if the composite risk score generated for the first applicant is not approximately equal to a composite risk score generated for the second applicant.

43. A system for calibrating a model for analyzing risk for underwriting insurance, comprising:
a means for inputting information and data; and
a processor for receiving information and data;
wherein the processor assigns a rate class to an applicant for insurance, the rate class corresponding to classifications assigned to applicants; determines a numerical target that corresponds to a median of the rate class; assigns the numerical target as a composite risk score for the applicant; and solves for at least one parameter used in generating the composite risk score.

44. A system in accordance with claim 43, wherein the rate class is designated or assigned by an underwriter.

45. A system in accordance with claim 43, wherein the composite risk score comprises a score based upon at least a first category and a second category, the first category comprising medical conditions or severities of medical conditions, and the second category comprising negative medical condition interactions.

46. A system in accordance with claim 43, wherein the model is revised to take into account the at least one parameter that is solved for and used to generate the composite risk score.

47. A system for analyzing risk for underwriting insurance comprising:
means for inputting data regarding at least one applicant for insurance, wherein at least one item of data relates to a first category and at least one item of data relates to a second category;
means for assigning a numerical risk factor to at least one item of data;
means for generating a first numerical risk score for the first category;
means for generating a second numerical risk score for the second category;
means for generating a composite risk score based on at least the first numerical risk score and the second numerical risk score; and
means for assigning a composite risk score to at least one applicant for insurance,
wherein the first category comprises medical conditions or severities of medical conditions and the second category comprises negative medical condition interactions.

48. A computer medium containing instructions for causing a processor to analyze risk for underwriting insurance, the medium comprising:
code for receiving data regarding at least one applicant for insurance, wherein at least one item of data relates to a first category and at least one item of data relates to a second category;
code for assigning a numerical risk factor to at least one item of data;
code for generating a first numerical risk score for the first category;
code for generating a second numerical risk score for the second category;
code for generating a composite risk score based on at least the first numerical risk score and the second numerical risk score; and
code for assigning a composite risk score to at least one applicant for insurance;
wherein the first category comprises medical conditions or severities of medical conditions and the second category comprises negative medical condition interactions.

49. A computer medium according to claim 48, further including code relating to a third category.

50. A computer medium according to claim 49, wherein the third category comprises one of functional information, lifestyle information, medications, and medical devices.

51. A computer medium according to claim 49, further including code for generating a third numerical risk score for the third category, and code for generating a composite risk score based on at least the first numerical risk score, the second numerical risk score, and the third numerical risk score.

52. A computer medium according to claim 48, further including code relating to a third category, code relating to a fourth category, and code relating to a fifth category.

53. A computer medium according to claim 52, wherein the third category comprises functional information, the fourth category comprises lifestyle information, and the fifth category comprises medications and medical devices.
